(19) United States
(12) Patent Application Publication
(10) Pub. No.: US 2025/0136371 A1
(43) Pub. Date: May 1, 2025

(54) PACKER WEAR BAR

(71) Applicant: The Heil Co., Chattanooga, TN (US)

(72) Inventors: Bryan Kelly Stewart, Chattanooga, TN (US); Mark Fraas, Centre, AL (US); David C. Gentry, Chattanooga, TN (US); London David Clay Brown, Fort Payne, AL (US); Tracy Mason, Mentone, AL (US); Kelly Johnson, Sylvania, AL (US); Donald Lynn Daniel, Valley Head, AL (US)

(21) Appl. No.: 18/931,794

(22) Filed: Oct. 30, 2024

Related U.S. Application Data
(60) Provisional application No. 63/594,805, filed on Oct. 31, 2023.

(51) Int. Cl. B65F 3/14; B65F 3/04

(52) U.S. Cl. CPC B65F 3/143; B65F 3/046

(57) ABSTRACT

A refuse collection vehicle with a wheeled vehicle chassis and a refuse-collecting body coupled to the wheeled vehicle chassis. The refuse-collecting body includes a refuse storage, a track, and a refuse packer. The refuse storage has a width direction and a length direction. The track extends along the length direction of the refuse storage. The refuse packer has a ram, a fixed bracket, and a wear bar. The ram defines a refuse-contacting surface in the width direction of the refuse storage. The fixed bracket is secured to a lateral surface of the ram in the length direction of the refuse storage. The wear bar engages the track and mechanically couples to the fixed bracket by a releasable fastener. The wear bar is supported on the fixed bracket by at least three spaced apart connection components in the length direction.

### CROSS-REFERENCE TO RELATED APPLICATIONS

This application claims the benefit under 35 U.S.C. § 119 (e) of U.S. Patent Application No. 63/594,805, entitled “Packer Wear Bar,” filed Oct. 31, 2023, which is incorporated herein by reference in its entirety.

### TECHNICAL FIELD

This disclosure relates to systems and methods for maintaining a refuse collection vehicle.

### BACKGROUND

Refuse collection vehicles have been used for generations for the collection and transfer of waste. Refuse collection vehicles can include a refuse storage and a refuse packer for moving refuse within the refuse storage. The refuse packer can move within the refuse storage along bars extending from the refuse packer that slide in tracks of the refuse storage.

### SUMMARY

Various aspects of this disclosure relate to maintaining a refuse collection vehicle. In an example aspect, a refuse collection vehicle includes a wheeled vehicle chassis and a refuse-collecting body coupled to the wheeled vehicle chassis. The refuse-collecting body includes a refuse storage, a track, and a refuse packer. The refuse storage has a width direction and a length direction. The track extends along the length direction of the refuse storage. The refuse packer includes a ram, a fixed bracket, and a wear bar. The ram defines a refuse-contacting surface in the width direction of the refuse storage. The fixed bracket is secured to a lateral surface of the ram in the length direction of the refuse storage. The wear bar engages the track and mechanically couples to the fixed bracket by a releasable fastener. The wear bar is supported on the fixed bracket by at least three spaced apart connection components in the length direction.

In an example aspect combinable with any other example aspect, the at least three spaced apart connection components include a first connection component, a second connection component, and a third connection component. The first connection component couples a first end of the fixed bracket to a first end of the wear bar. The second connection component couples a second end of the fixed bracket to a second end of the wear bar. The second end of the fixed bracket is opposite the first end of the fixed bracket and the second end of the wear bar is opposite the first end of the wear bar. The third connection component is positioned along the fixed bracket at a distance between the first end and the second end of the fixed bracket. The third connection component couples the wear bar to the fixed bracket between the first ends and the second ends.

In an example aspect combinable with any other example aspect, the first connection component includes a boss and a cavity. The boss is positioned at the first end of the fixed bracket. The boss extends from the first end toward the second end. The cavity is in the first end of the wear bar. The cavity is shaped to mate with the boss about the boss.

In an example aspect combinable with any other example aspect, the boss is offset from a first surface of the fixed bracket in a first direction.

In an example aspect combinable with any other example aspect, the second connection component includes a bracket plate, wear bar plate, and a releasable fastener. The bracket plate is positioned at the second end of the fixed bracket. The bracket plate includes a recessed surface and a threaded void. The threaded void extends through the bracket plate from the recessed surface. The wear bar plate is positioned at the second end of the wear bar. The wear bar plate includes a key and an aperture. The key mates with the recessed surface of the bracket plate. The aperture extends through the key. The releasable fastener includes threads. The releasable fastener is sized to pass through the aperture of the wear bar plate and threadedly couple to the threaded void of the bracket plate to couple the wear bar plate to the bracket plate.

In an example aspect combinable with any other example aspect, the bracket plate is offset from the first surface in a second direction opposite the first direction.

In an example aspect combinable with any other example aspect, the wear bar plate extends from the wear bar plate perpendicular past the first surface of the fixed bracket positioning the key to mate with the recessed surface of the bracket plate.

In an example aspect combinable with any other example aspect, the third connection component includes a U-shaped boss and a block. The U-shaped boss is positioned on the first surface of the fixed bracket. An opening of the U-shaped boss is oriented toward the second end. The block is positioned on a first surface of the wear bar. The first surface of the wear bar faces the first surface of the fixed bracket. The block is shaped to pass through the opening of the U-shaped boss and couple to U-shaped boss.

In an example aspect combinable with any other example aspect, the track is a first track. The fixed bracket is a first fixed bracket and the wear bar is a first wear bar. The refuse-collecting body further includes a second track extending along the length direction of the refuse storage. The first and second tracks are positioned on opposite sides of the refuse-collecting body. The refuse packer includes a second fixed bracket and a second wear bar. The second fixed bracket is secured to another lateral surface opposite the lateral surface of the ram in the length direction of the refuse storage. The second wear bar engages the second track and mechanically couples to the second fixed bracket by a second releasable fastener. The second wear bar is supported on the second fixed bracket by the at least three spaced apart connection components in the length direction.

In an example aspect combinable with any other example aspect, the fixed bracket further includes an aperture to pass grease to the track.

In an example aspect combinable with any other example aspect, the refuse packer further includes a grease assembly coupled to the aperture of the fixed bracket. The grease assembly supplies grease through the aperture to the track. The grease assembly includes a grease bracket, a grease fitting, and a grease supply conduit. The grease bracket is positioned on a non-refuse contacting surface of the refuse packer. The grease fitting is coupled to the grease bracket. The grease supply conduit is coupled between the grease fitting and the aperture. The grease supply conduit conducts grease from the grease fitting of the grease bracket to the aperture.

In another example aspect, a packer wear bar assembly includes a fixed bracket assembly, wear bar assembly, and a threaded fastener. The fixed bracket assembly couples to a refuse packer. The fixed bracket assembly includes a fixed bracket body, a boss, a bracket plate, and a U-shaped boss. The fixed bracket body has a first end and second end opposite the first end. A first surface of the fixed bracket body extends between the first end and the second end. The boss is positioned at the first end of the fixed bracket body. The boss is offset from the first surface in a first direction and extends parallel to the first surface toward the second end. The bracket plate is positioned at the second end of the fixed bracket body. The bracket plate is offset from the first surface in a second direction opposite the first direction. The bracket plate has a recessed surface and a threaded void extending through the bracket plate from the recessed surface. The U-shaped boss is positioned on the first surface of the fixed bracket body between the first end and the second end. An opening of U-shaped boss is oriented toward the second end. The wear bar assembly couples to the fixed bracket assembly. The wear bar assembly includes a wear bar body, a wear bar plate, and a block. The wear bar body has a first end and second end opposite the first end. The wear bar body has a cavity in the first end of the wear bar body. The cavity is shaped to mate with the boss of the fixed bracket assembly about the boss. The wear bar plate is positioned at the second end of the wear bar body. A portion of the wear bar plate extends from the wear bar body perpendicular to the first surface toward and past the first surface of the fixed bracket body. The portion of the wear bar plate extending from the wear bar plate has a key and an aperture. The key extends from a first surface of the portion to mate with the recessed surface of the bracket plate. The aperture extends from a second surface of the portion to the first surface of the portion. The block is positioned on a first surface of the wear bar body between the first end and the second end. The first surface of the wear bar body faces the first surface of the fixed bracket body. The block is shaped to pass through the opening of the U-shaped boss and is coupled to U-shaped boss. The threaded fastener is sized to pass through the aperture of the portion of the wear bar plate and is threadedly coupled to the threaded void of the bracket plate.

In an example aspect combinable with any other example aspect, a perimeter of the boss is cross-shaped.

In an example aspect combinable with any other example aspect, a length of the cross-shaped boss is greater than or equal to a width of the cross-shaped boss.

In an example aspect combinable with any other example aspect, lengths of two opposing surfaces of the cross-shaped boss are greater than other lengths of two other opposing surfaces of the cross-shaped boss.

In an example aspect combinable with any other example aspect, the boss defines an aperture extending from a first surface of the boss to a second surface of the boss. The aperture defines a first opening on the first surface and a second opening on the second surface.

In an example aspect combinable with any other example aspect, a grease fitting is coupled to the first opening.

In an example aspect combinable with any other example aspect, opposing inner surfaces of the U-shaped boss taper toward each other from the opening of the U-shaped boss to a bottom inner surface of the U-shaped boss and opposing side surfaces of the block taper toward each other from the second end to the first end such that the opposing side surfaces of the block align with the opposing inner surfaces of the U-shaped boss.

In an example aspect combinable with any other example aspect, the block couples to the U-shaped boss by at least one of a clearance fit.

In an example aspect combinable with any other example aspect, the fixed bracket assembly further includes a pair of tabs positioned at the first end. The pair of tabs extend from the boss from the first end away from the second end. Each tab of the pair of tabs defines an aperture. The wear bar assembly further includes another pair of tabs coupled to the wear bar plate. The pair of tabs extend from the wear bar plate from the second end away from the first end. Each of the other pair of tabs defines another aperture.

In an example aspect combinable with any other example aspect, the aperture is an oval shape.

In an example aspect combinable with any other example aspect, the pairs of tabs have rounded corners.

In an example aspect combinable with any other example aspect, a first portion of each tab of the pair of tabs extend farther from the boss and plate than a second portion.

In an example aspect combinable with any other example aspect, the aperture is positioned in the first portion.

In an example aspect combinable with any other example aspect, the wear bar plate further includes multiple protrusions extending from a side surface of the wear bar plate.

In an example aspect combinable with any other example aspect, the fixed bracket body and the wear bar body each include a respective square tube.

In an example aspect combinable with any other example aspect, the packer wear bar assembly includes two pairs of angled plate coupled about the fixed bracket body and the wear bar body.

In an example aspect combinable with any other example aspect, ends of the angled plate are coplanar with ends of the fixed bracket body and the wear bar body.

In an example aspect combinable with any other example aspect, the wear bar body further defines a top surface and a bottom surface coupled to the first surface, and a side surface coupled between the bottom surface and the top surface opposite the first surface. The wear bar assembly further includes multiple wear plates coupled to the top surface, the side surface, and the bottom surface.

In an example aspect combinable with any other example aspect, the first end of the fixed bracket body includes a notch to mate to the boss.

In an example aspect combinable with any other example aspect, the boss and the cavity define a first connection point; the U-shaped boss and the block define a second connection point; the recessed surface of the bracket plate, the key, and the threaded fastener define a third connection point; and each of first, second, and third connection points restrain movement of the wear bar assembly relative to the fixed bracket assembly in three axes.

In another example aspect, a refuse packer assembly includes a refuse packer, a pair of wear bar assemblies, and a grease assembly. The wear bar assemblies are coupled to opposite sides of the refuse packer. Each of the wear bar assemblies ride in a respective horizontal groove of a refuse body. Each wear bar assembly includes a fixed bracket and wear bar. The fixed bracket is secured to a length-oriented non-refuse-packing outer surface of the refuse packer. The wear bar engages the respective horizontal groove of the refuse body and is mechanically coupled to the fixed bracket by a releasable fastener. The grease assembly is coupled to the refuse packer and the pair of wear bar assemblies. The grease assembly supplies grease through the wear bar assemblies to the respective horizontal grooves.

In an example aspect combinable with any other example aspect, the wear bar is supported on the fixed bracket by at least three spaced apart connection components.

In an example aspect combinable with any other example aspect, the grease assembly includes a grease bracket, one or more grease fittings, and multiple grease supply conduits. The grease bracket is positioned on a length-oriented non-refuse-packing inner surface of the refuse packer. One or more grease fittings are coupled to the grease bracket. One or more grease fittings are coupled to the wear bar assembly. The grease supply conduits are coupled between grease fittings of the grease bracket and the grease fittings of the wear bar assembly.

In another example aspect, a pair of wear bar assemblies coupled to a refuse packer positioned in a refuse storage are lubricated. Lubricating the pair of wear bar assemblies includes receiving grease from a grease fitting at multiple grease supply conduits, with the grease fitting positioned on the refuse packer; conducting the grease through the grease supply conduits to the pair of wear bar assemblies; and disposing the grease from each of the wear bar assemblies to a space outside the wear bar assemblies.

In an example aspect combinable with any other example aspect, disposing the grease from each of the wear bar assemblies to the space outside the wear bar assemblies applies the grease to a pair of tracks, lubricating the track. Each track supports the refuse packer by one of the wear bar assemblies.

In an example aspect combinable with any other example aspect, lubricating the pair of wear bar assemblies includes, before receiving grease from the grease fitting at the grease supply conduits, supplying the grease to the grease fitting.

One or more implementations described in the present specification may increase waste collection efficiency. For example, wear bar assemblies described herein can reduce the time and complexity of replacing wear bars coupled to refuse packers.

Implementations of this disclosure may also reduce the likelihood of damaging the wear bars and tracks of refuse collection vehicles during use. For example, the wear bars and tracks can be lubricated via an integrated greasing system to reduce or prevent damage to these components.

Implementations described herein may also reduce the risk of injury to vehicle operators by reducing the need for the operators to enter the refuse storage to manually lubricate the wear bars and tracks. In addition, the wear bar assemblies described herein are easy to install and replace.

It is appreciated that methods in accordance with the present specification may include any combination of the aspects and features described herein. That is, methods in accordance with the present specification are not limited to the combinations of aspects and features specifically described herein, but also include any combination of the aspects and features provided.

The details of one or more implementations of the subject matter described in this disclosure are set forth in the accompanying drawings and the description below. Other features, objects, and advantages of the subject matter will be apparent from the description and drawings, and from the claims.

### DESCRIPTION OF DRAWINGS

FIG. 1 is a side perspective view of a refuse collection vehicle with a refuse packer in a first position within a storage body of the refuse collection vehicle.

FIG. 2 is a top perspective view of the refuse collection vehicle of FIG. 1 with the refuse packer in a second position in the refuse storage.

FIG. 3 is a rear perspective view of the refuse collection vehicle of FIG. 1 with the packer within the refuse storage.

FIG. 4 is a perspective view of a refuse packer with a packer wear bar assembly.

FIG. 5 is a perspective, partially exploded view of the refuse packer and packer wear bar assembly of FIG. 4.

FIG. 6 is an exploded view of the fixed bracket of FIG. 5.

FIG. 7 is a side view of a first connection component of the fixed bracket of FIG. 4.

FIG. 8 is a cross-sectional view of the first connection component of FIG. 7.

FIG. 9 is a side view of a second connection component of the fixed bracket of FIG. 4.

FIG. 10 is a perspective view of a U-shaped boss of a third connection component of the fixed bracket of FIG. 4.

FIG. 11 is a perspective view of the wear bar of FIG. 4.

FIG. 12 is a side view of the wear bar of FIG. 4.

FIG. 13 is a perspective view of a greasing system of the refuse packer of FIG. 4.

### DETAILED DESCRIPTION

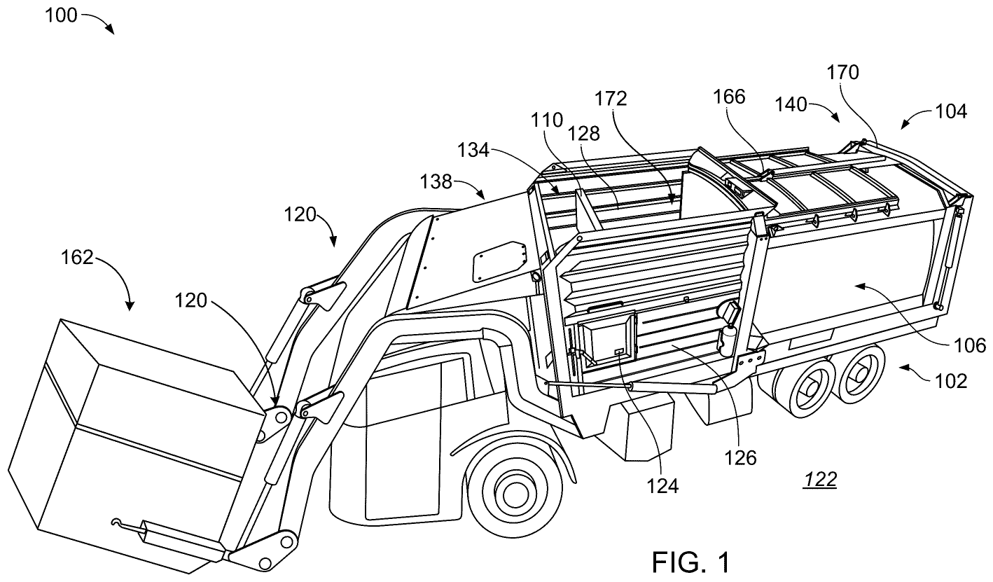

FIG. 1 depicts an example refuse collection vehicle 100. The refuse collection vehicle 100 operates to collect and transport refuse (e.g., garbage and/or recycling). The refuse collection vehicle 100 can also be described as a garbage collection vehicle, or garbage truck. The refuse collection vehicle 100 lifts a customer container 162 that contains refuse, and to empty refuse from the customer container 162 into an onboard refuse container 104 to enable transporting the refuse to a collection site, compacting of the refuse, and/or other refuse handling activities.

The body components of the vehicle 100 can include various components that are appropriate for the particular type of vehicle 100. For example, the vehicle 100 may be a front-loading truck with a fork assembly 120, as shown in FIG. 1 which repositions and/or reorients the customer container 162 to move the refuse from the customer container 162 into the storage body 106. Alternatively, the vehicle may be a side-loading truck with an automated side loader (ASL), a rear loading truck, a roll off truck, or some other type of garbage collection vehicle. A front-loading vehicle, such as the example shown in FIG. 1, may include body components involved in the operation of the vehicle 100, such as a pump, tailgate, packer, fork assembly 120, and so forth. A side loader may include such components as an arm and/or grabbers, as well as other body components such as a pump, a tailgate, a packer, and so forth. A rear loading vehicle may include body components such as a pump, blade, tipper, and so forth. A roll off vehicle may include body components such as a pump, hoist, cable, and so forth. Body components may also include other types of components that operate to bring garbage into a hopper 172 (or other storage area) of a truck, compress and/or arrange the garbage in the vehicle, and/or expel the garbage from the vehicle.

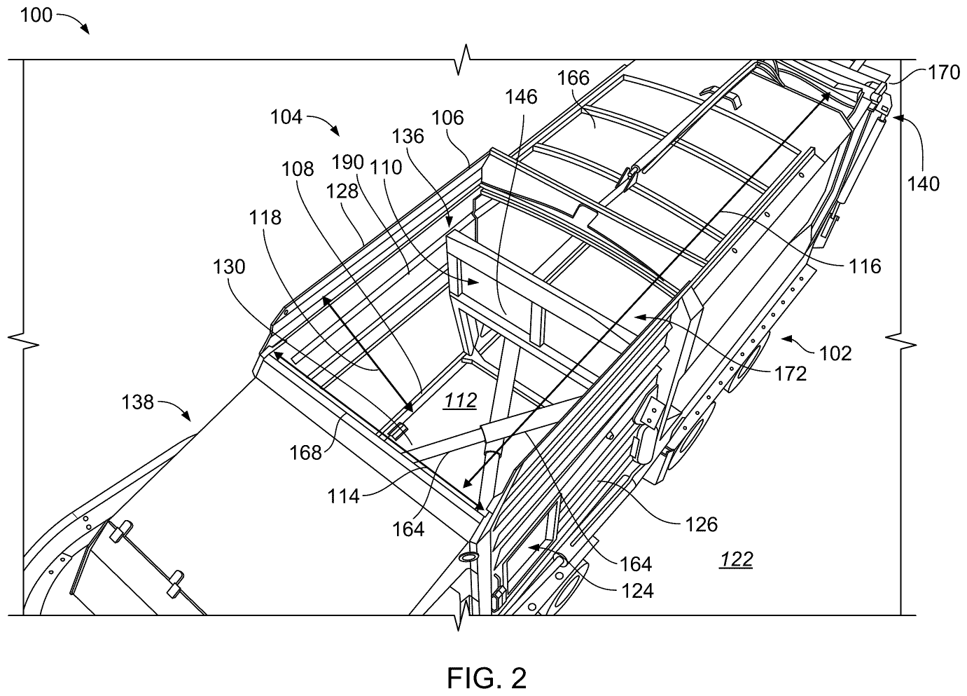

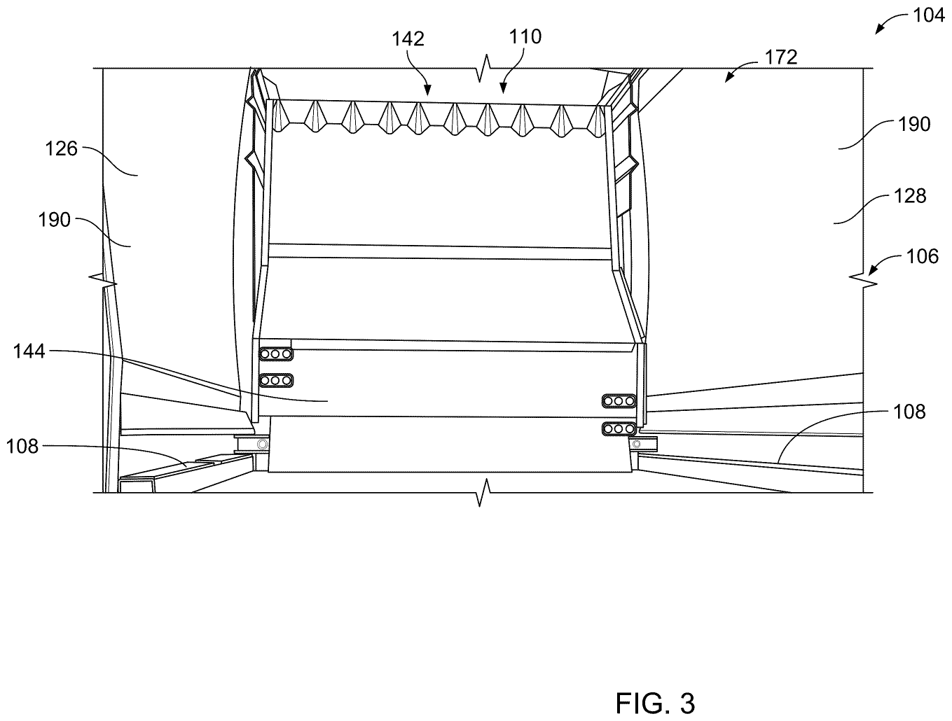

Referring to FIGS. 1 and 2, the refuse collection vehicle 100 has a wheeled vehicle chassis 102 and the refuse container 104 mounted on the wheeled vehicle chassis 102. The refuse container 104 has a storage body 106, a track 108 (shown in FIGS. 2 and 3) extending along a floor of the storage body 106, and a refuse packer 110 (also referred to as a packer panel, an ejector, and an ejector panel, among other terms). The refuse packer 110 translates along the track 108 within the storage body 106 between a forward (retracted) position, (as depicted in FIG. 1) and a rearward (extended) position (as depicted in FIG. 2) in a direction substantially parallel with a length direction 116 of the storage body 106.

Referring to FIG. 2, the refuse collection vehicle 100 has a hydraulic system including hydraulic cylinders 164 to move the refuse packer 110 along the tracks 108. The hydraulic cylinders 164 are coupled to the storage body 106 and the refuse packer 110. The hydraulic cylinders 164 are positioned within the storage body 106. The hydraulic cylinders 164 extend and retract to move the refuse packer 110. In this implementation, the hydraulic cylinders are arranged in an X-shaped arrangement. Alternatively, the hydraulic cylinders 164 can be arranged in a parallel arrangement.

Referring to FIG. 2, the storage body 106 has an interior volume 112 between a pair of side walls 126, 128, a top surface (e.g., roof) 166, a floor 130 (inner bottom surface), and a front wall 168. A width direction 114 of the interior volume 112 is defined between the pair of side walls, a length direction 116 of the interior volume 112 is defined between the front wall and a tailgate 170 of the vehicle 100, and a height direction 118 of the interior volume 112 is defined between the floor and the top surface. The storage body 106 has a door 124 that provides access from the environment 122 (a space outside the storage body 106) into the interior volume 112 of the storage body 106 through side walls 126, 128.

The refuse packer 110 includes a ram 142. The ram 142 defines a refuse-contacting surface 144 (facing toward the rear end 140) and a non-refuse contacting surface 146 (facing the forward end 138). The ram 142 extends across the width direction 114 in the storage body 106. The refuse-contacting surface 144 contacts and compacts the refuse in the storage body 106 when the ram 142 moves from the first position 134 to the second position 136.

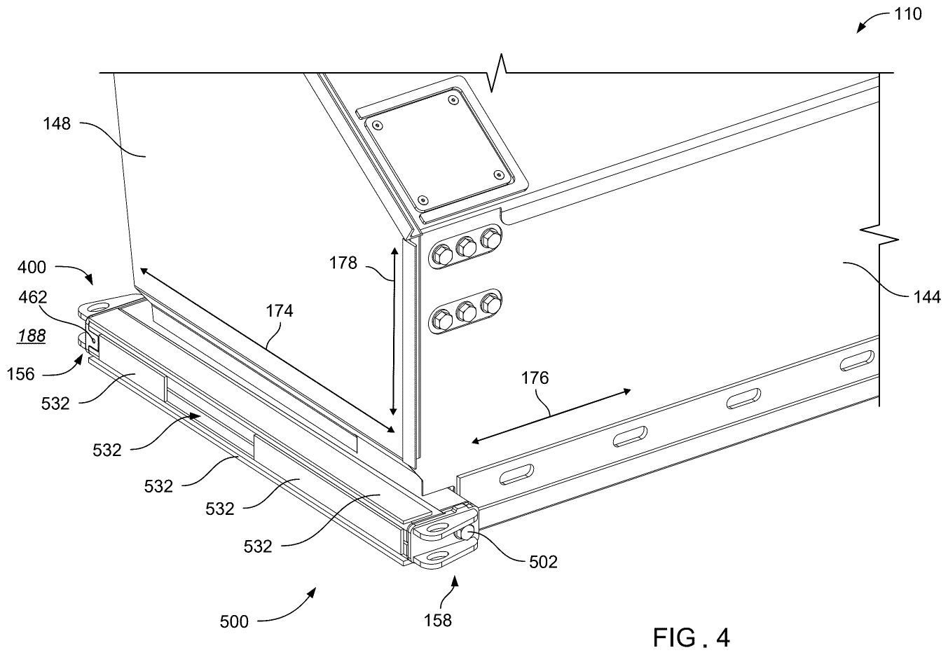

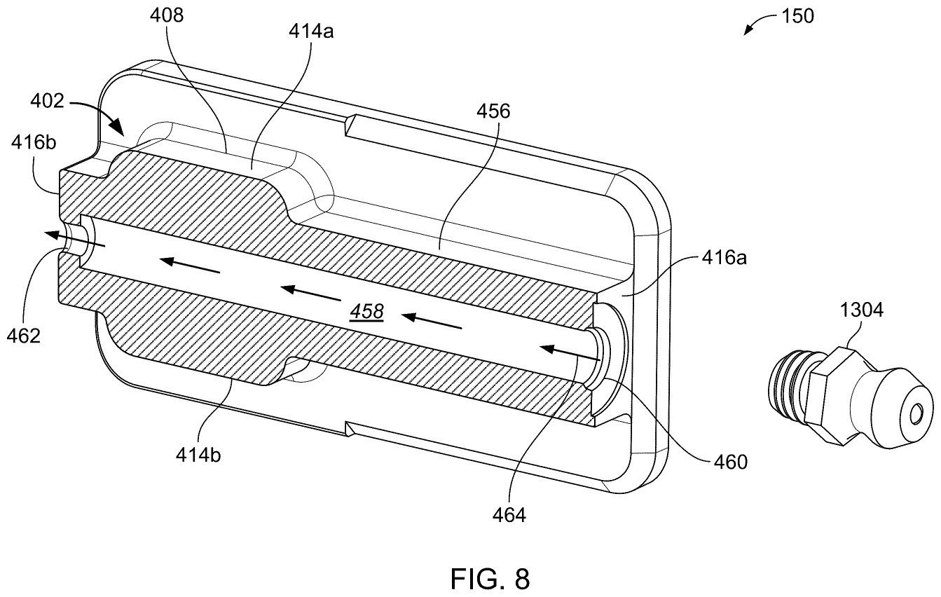

Referring to FIGS. 1-3, the track 108 is coupled to an inner surface of the side walls 126, 128 of the storage body 106. The track 108 extends along the side walls 126, 128. In this implementation, the track 108 is also positioned adjacent or in contact with the floor 130 of the storage body 106. The track 108 extends along the length direction 116 of the storage body 106. As shown in FIG. 3, the track 108 can include two parallel tracks 108 extending along opposing inner side surfaces 190 of the storage body 106. As will be described in detail with reference to FIGS. 4-13, the tracks 108 receive a packer wear bar assembly 132 and guide the refuse packer 110 within the storage body 106 to move refuse within the storage body 106.

The refuse packer 110 moves along the tracks 108 between a first position 134 (shown in FIG. 1) and a second position 136 (shown in FIG. 2) within the storage body 106. When the refuse packer 110 is in the first position 134, the refuse packer 110 is positioned proximal a forward end 138 of the refuse collection vehicle 100, which allows refuse collected using the fork assembly 120 to be received into the hopper 172 portion of the interior volume 112 of the storage body 106. In this implementation, the refuse packer 110 abuts the forward end 138 when the refuse packer 110 is in the first position 134. When the hopper 172 is full (or at any other suitable time determined by the operator), the packer 110 can be actuated toward the rear of the vehicle 100 to empty the hopper 172 and, in this implementation, compact the refuse in the storage body 106. For example, when the refuse packer 110 moves from the first position 134 to the second position 136, refuse contained within the hopper 172 is pushed out of the hopper 172 by the refuse packer 110 towards a rear end 140 of the refuse collection vehicle 100. In this implementation, when a volume of refuse in the storage body 106 is above a threshold volume and the refuse packer 110 moves from the first position 134 to the second position 136, the refuse packer 110 compacts the refuse (i.e., reduces the volume of the refuse in the storage body 106).

Repeated movement of the refuse packer 110 between the first position 134 and the second position 136 can cause the packer wear bar assembly 132 to wear and become damaged, requiring replacement.

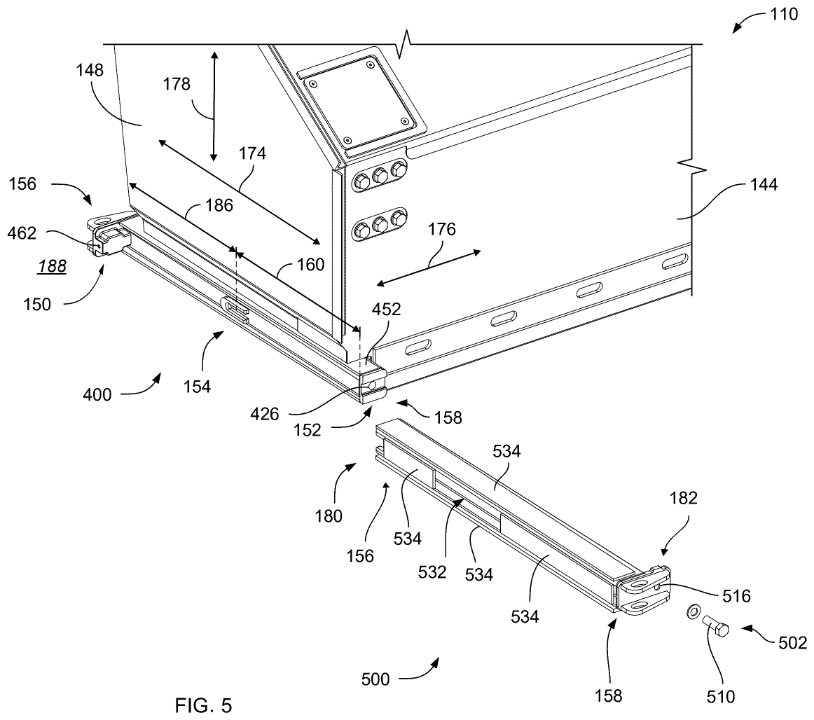

FIGS. 4 and 5 depict a packer wear bar assembly that enables fast and simple replacement of the wear bar. Referring to FIGS. 4 and 5, the packer wear bar assembly 132 includes a fixed bracket 400 and a wear bar 500. The fixed bracket 400 is fixed to the refuse packer 110, and the wear bar 500 is removably coupled to fixed bracket 400.

The refuse packer 110 defines a length direction 174, a width direction 176, and a height direction 178. The length direction 174 of the refuse packer 110 is substantially parallel to the length direction 116 of the storage body 106 when the refuse packer 110 is positioned within the storage body 106 and coupled to the storage body 106 via the tracks 108. The width direction 176 of the refuse packer 110 is substantially parallel to the width direction 114 of the storage body 106 when the refuse packer 110 is positioned within the storage body 106 and coupled to the storage body 106 via the tracks 108. The height direction 178 of the refuse packer 110 is substantially parallel to the height direction 118 of the storage body 106 when the refuse packer 110 is positioned within the storage body 106 and coupled to the storage body 106 via the tracks 108.

The fixed bracket 400 is secured to a lateral surface 148 of the ram 142 in the length direction 116 of the storage body 106. When the refuse packer 110 is positioned within the storage body 106, the wear bar 500 engages with and slides in the tracks 108 extending along the length direction 116 of the storage body 106, allowing the refuse packer 110 to move between the first position 134 and the second position 136. The wear bar 500 is mechanically coupled to the fixed bracket 400 by a releasable fastener 502. The wear bar 500 slides along the tracks 108, permitting the refuse packer 110 to move. In this implementation, the fastener 502 has threads 510. For example, the fastener 502 can be a hex bolt.

The wear bar 500 is supported on the fixed bracket 400 by at least three connection components on each of the wear bar 500 and the fixed bracket 400. Each of the three connection components on the wear bar 500 and fixed bracket 400 mate with the respective other component to fix the wear bar 500 relative to the fixed bracket 400. Each of the three connection components are spaced apart along the length direction 174 of the refuse packer 110.

The connection components on the fixed bracket 400 include a fixed bracket-first connection component 150, a fixed bracket-second connection component 152, and a fixed bracket-third connection component 154. The connection components on the wear bar 500 include a wear bar-first connection component 180, a wear bar-second connection component 182, and a wear bar-third connection component 184.

The fixed bracket-first connection component 150 and the wear bar-first connection component 180 couple together such that the fixed bracket 400 supports the wear bar 500 at a first point. The fixed bracket-first connection component 150 and the wear bar-first connection component 180 are positioned at a first end 156 of the packer wear bar assembly 132.

The fixed bracket-second connection component 152 and the wear bar-second connection component 182 couple together such that the fixed bracket 400 supports the wear bar 500 at a second point. The fixed bracket-second connection component 152 and the wear bar-second connection component 182 are positioned at a second end 158 of the packer wear bar assembly 132.

The fixed bracket-third connection component 154 and the wear bar-third connection component 184 couple together such that the fixed bracket 400 supports the wear bar 500 at a third point. The fixed bracket-third connection component 154 and the wear bar-third connection component 184 are positioned between and separate from the first end 156 and the second end 158 of the packer wear bar assembly 132.

In this implementation, each corresponding pair of the fixed bracket-first connection component 150 and the wear bar-first connection component 180, the fixed bracket-second connection component 152 and the wear bar-second connection component 182, and the fixed bracket-third connection component 154 and the wear bar-third connection component 184 are referred to as “connection points.” Each pair of these connection points restrain movement of the wear bar 500 in all the directions (the length direction 174, the width direction 176, and the height direction 178). That is, movement of the wear bar 500 relative to the fixed bracket 400 is constrained at each connection point in all three axes (X, Y, and Z).

The fixed bracket-first connection component 150 and the wear bar-first connection component 180 are positioned at the first end 156 of the packer wear bar assembly 132. The first end 156 of the packer wear bar assembly 132 corresponds to the non-refuse contacting surface 146 of the refuse packer 110. When the refuse packer 110 is positioned in the storage body 106 on the tracks 108, the non-refuse contacting surface 146 of the refuse packer 110 faces the forward end 138 of the vehicle 100. Accordingly, the first end 156 is closer to the forward end 138 of the vehicle 100 than the second end 158.

The fixed bracket-second connection component 152 and the wear-bar-second connection component are positioned at the second end 158 of the packer wear bar assembly 132 opposite the first end 156. The second end 158 of the packer wear bar assembly 132 corresponds to the refuse-contacting surface 144 of the refuse packer 110. When the refuse packer 110 is positioned in the storage body 106 on the tracks 108, the refuse-contacting surface 144 of the refuse packer 110 faces toward the rear end 140. Accordingly, the second end 158 is closer to the rear end 140 than the first end 156. The fixed bracket-second connection component 152 and the wear bar-second connection component 182 are spaced apart (distinct and separate) from the pair of the fixed bracket-first connection component 150 and the wear bar-first connection component 180 and the pair of the fixed bracket-third connection component 154 and the wear bar-third connection component 184.

The fixed bracket-third connection component 154 and the wear bar-third connection component 184 are between the first end 156 of the packer wear bar assembly 132 and the second end 158 of the packer wear bar assembly 132 and spaced apart (distinct and separate) from both of the other connection points (the pair of the fixed bracket-first connection component 150 and the wear bar-first connection component 180 and the pair of the fixed bracket-second connection component 152 and the wear bar-second connection component 182). Referring to FIG. 5, the fixed bracket-third connection component 154 and the wear bar-third connection component 184 are spaced apart from the fixed bracket-first connection component 150 and the wear bar-first connection component 180 by a distance 160. The fixed bracket-third connection component 154 and the wear bar-third connection component 184 are spaced apart from the fixed bracket-second connection component 152 and the wear bar-second connection component 182 by a distance 186. The distances 160 and 186 can be the same or different. The distances 160 and 186 can be selected to support the wear bar 500 at the third connection components 154, 184, between the first connection components 150, 180 and second connection components 180, 182. In this implementation, the third connection components 154, 184 are positioned generally in the middle of the respective first and second connection components 150, 152, 180, 182. In other implementations, the third connection components 154, 184 can be positioned closer to or farther away from either the first end 156 or the second end 158.

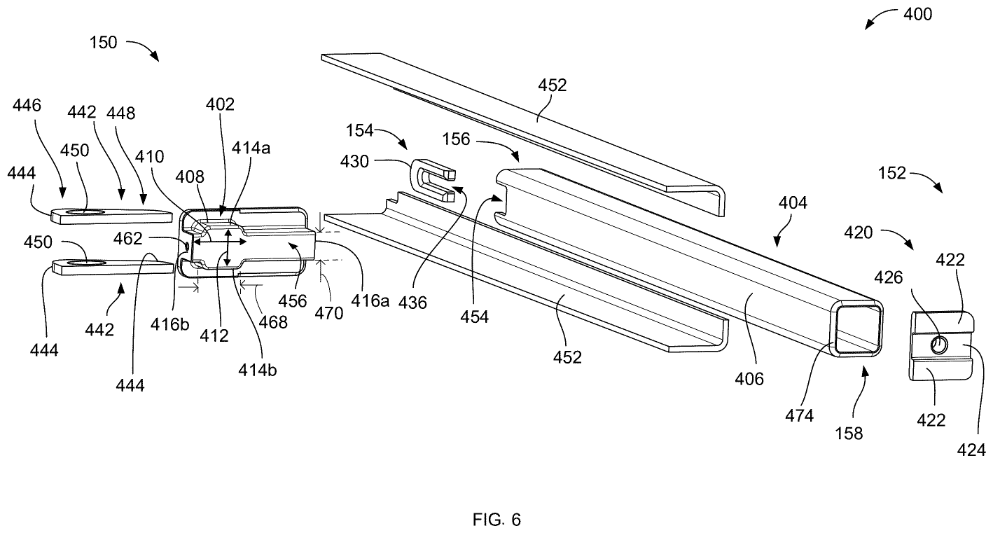

Referring to FIGS. 5-8, the fixed bracket-first connection component 150 of the fixed bracket 400 receives and couples to the wear bar-first connection component 180 of the wear bar 500 to support the wear bar 500 at the first end 156. As can be seen in FIG. 6, the fixed bracket-first connection component 150 includes a boss 402 positioned at the first end 156 of a fixed bracket body 404. The boss 402 extends from the first end 156 of the fixed bracket body 404 toward the second end 158, that is, toward the refuse-contacting surface 144 in the length direction 116 toward the rear end 140. As can be seen in FIG. 5, the fixed bracket 400 includes a first surface 406 extending along the length direction 174 of the packer 110 between the first end 156 and the second end 158 of the fixed bracket 400, and the boss 402 is offset from the first surface 406 of the fixed bracket body 404 outward from the fixed bracket body 404 in a first direction corresponding to the width direction 176 (i.e., away from the lateral surface 148 of the refuse packer 110).

Referring to FIGS. 5 and 6, the boss 402 has a perimeter 408 that defines a shape that engages with and couples to the first end 156 of the wear bar 500. In this implementation, the perimeter 408 of the boss 402 defines a cross-shape.

The boss 402 is further defined by a length 410 and a width 412. In this implementation, the length 410 of the cross-shaped boss 402 is greater than or equal to the width 412 of the cross-shaped boss 402.

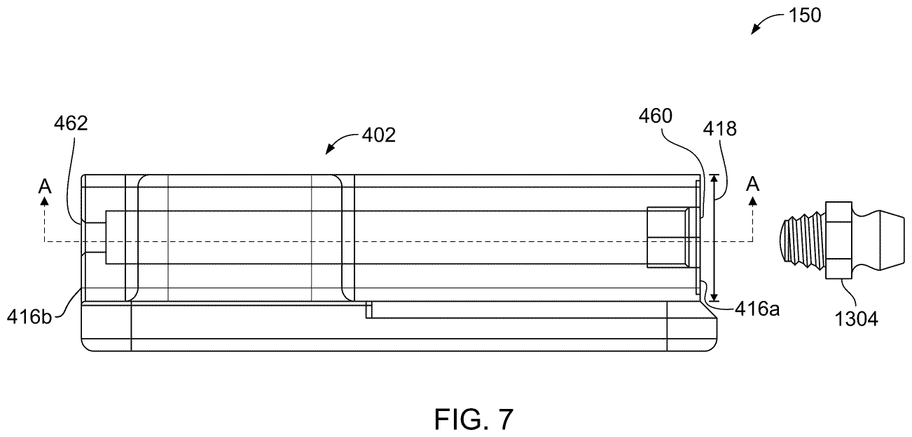

Referring to FIG. 7, the boss 402 has a height 418. The boss 402 extends from the first end 156 toward the second end 158b by the height 418.

Referring to FIGS. 5-7, the boss 402 is further defined by at least two sets of opposing surfaces: opposing surfaces 414a, 414b and opposing surfaces 416a, 416b. The opposing surfaces 414a, 414b are defined by a length 468 and the height 418. The opposing surfaces 416a, 416b are defined by a width 470 and the height 418. In this implementation, the length 468 of the two opposing surfaces 414a, 414b is greater than the width 470 of the other opposing surfaces 416a, 416b. Alternatively, the length 468 of the opposing surfaces 416a, 416b can be the same or less than the width 470 of the other opposing surfaces 416a, 416b.

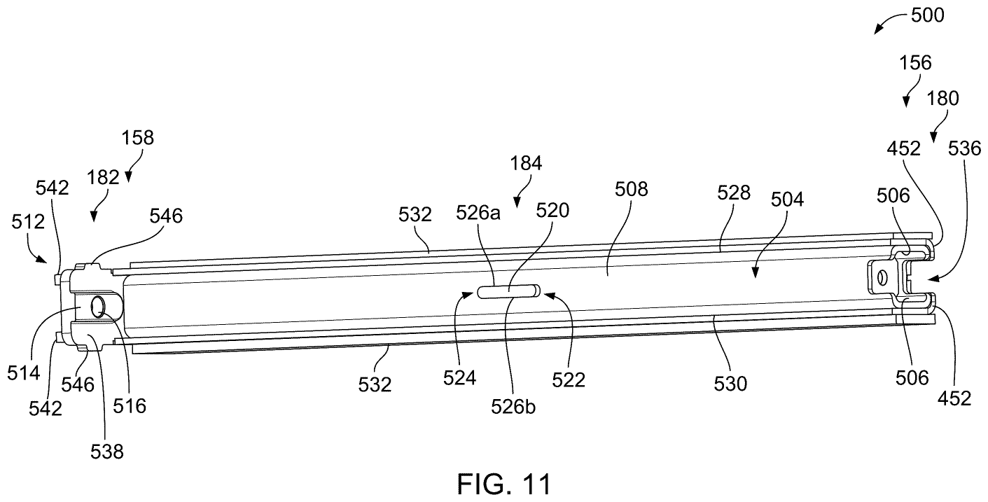

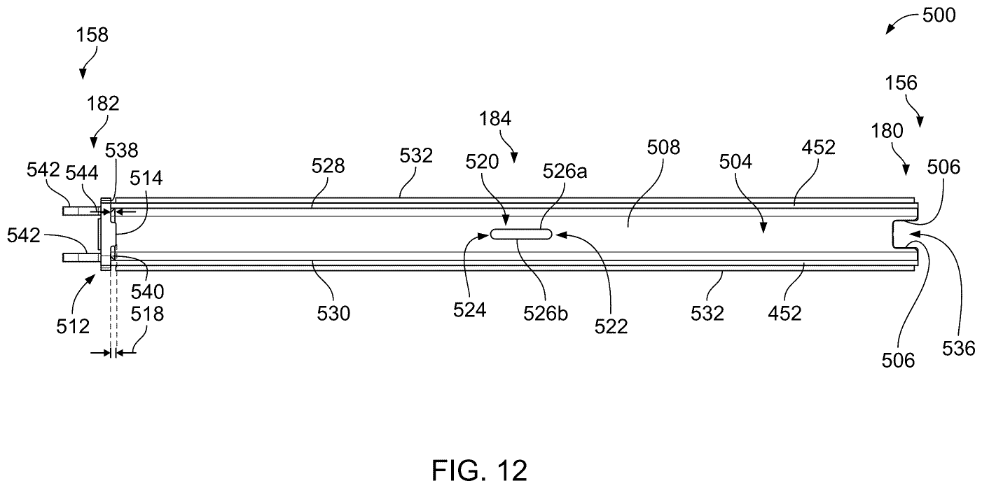

The length 410 and width 412 of the boss 402 are sized to interface with the wear bar-first connection component 180, and the wear bar body 504 (described in more detail in reference to FIGS. 11-12) fits over boss 402. The interface between the boss 402 and the wear bar body 504 can reduce or prevent rotation or translation of the wear bar body 504 relative to the boss 402.

The rotational constraint provided by the interface between the wear bar body 504 and the boss 402 enables the wear bar 500 to be coupled to the fixed bracket 400 without the use of mechanical fasteners (e.g., bolts) that are only accessible from the forward end 138 (in front of) the refuse packer 110. As such, the wear bar 500 may be removed from the fixed bracket 400 removing a single fastener 502 accessible from the rear end 140 of the vehicle 100.

In some implementations, the components of the fixed bracket 400 can be assembled by welding. In some implementations, the boss 402 and a pair of tabs 442 (described in further detail in reference to FIGS. 5, 6, 11, and 12) can be formed as a single casting to reduce welds. In some implementations, some or all of the fixed bracket 400 can be formed as a unitary piece. For example, the fixed bracket 400 can be cast, machined, or cast then machined.

Referring to FIGS. 4-5 and 11-12, the wear bar-first connection component 180 couples to the fixed bracket-first connection component 150 to support the wear bar 500 at the first end 156. The wear bar-first connection component 180 has a cavity 536 positioned at the first end 156 of a wear bar 500. The cavity 536 is sized to receive and extend about the boss 402. The cavity 536 is inset into a wear bar body 504 (described in more detail in reference to FIGS. 11 and 12) such that inner surfaces 506 of the cavity mate to the perimeter 408 of the boss 402. In addition, the cavity 536 is sized to clear the grease system 1300 coupled to the boss 402. As previously discussed, the cavity 536 of the wear bar body 504 fits over the boss 402 and interfaces with the boss 402 to reduce rotation of the wear bar body 504.

Referring to FIGS. 5, 6, and 9, the second connection component 152 of the fixed bracket 400 receives and couples to the second connection component 182 of the wear bar 500 to support the wear bar 500 at the second end 158. The second connection component 152 of the fixed bracket 400 includes a bracket plate 420 positioned at the second end 158 of the fixed bracket 400. The bracket plate 420 is offset from the first surface 406 of the fixed bracket 400 in a second direction in the width direction 176 toward the fixed bracket body 404.

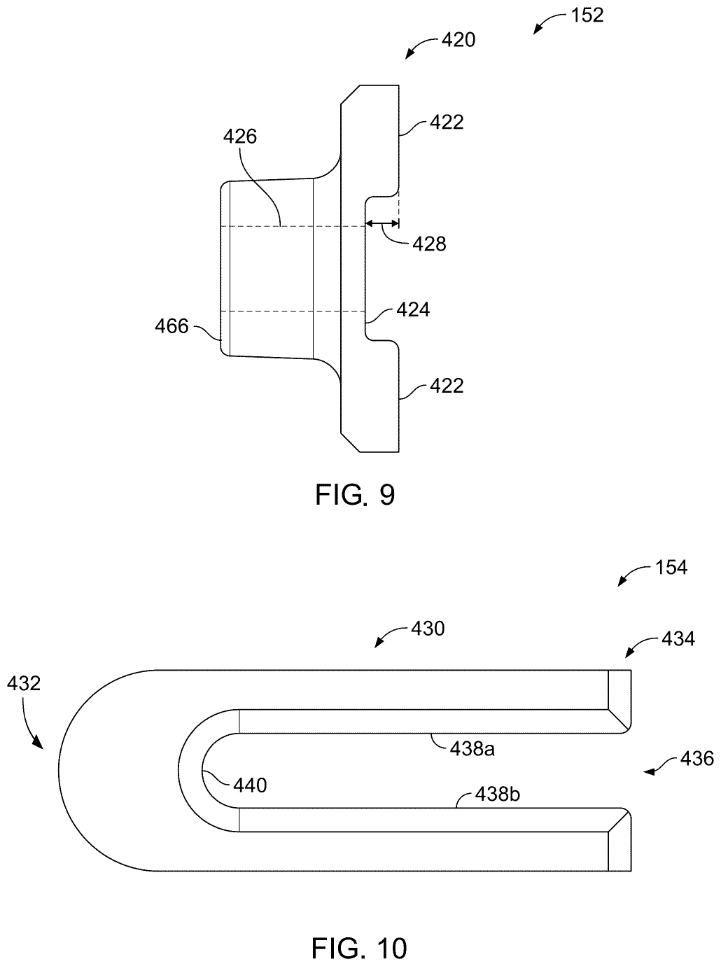

The bracket plate 420 has a first surface 422, a recessed surface 424, and a void 426. The recessed surface 424 is recessed from (i.e., offset from) the first surface 422 in the length direction 116 by a depth 428 (shown in FIG. 9). Referring to FIGS. 9 and 11, the wear bar 500 has a wear bar plate 512 that defines a key 514, and the bracket plate 420 mates with the key 514 of the wear bar 500. In some implementations, the depth 428 of the recessed surface 424 is greater than or equal to the height 518 of the key 514 of the wear bar 500. The interface of the recessed surface 424 and the key 514 can reduce a shear load applied to the fastener 502 by providing a larger load path between the second connection components 152, 182.

In this example, the recessed surface 424 is rectangular. Alternatively or in addition, the recessed surface could be any suitable shape including, but not limited to, round, triangular, square-shaped, trapezoidal-shaped, diamond-shaped, star-shaped, or some other geometric, non-geometric shape, or complex shape. As shown in FIG. 5, the recessed surface 424 extends across the bracket plate 420. Alternatively, the recessed surface could extend across a portion of the bracket plate. Alternatively, the first surface could be offset toward the first end, such that the recessed surface is a raised surface. The first surface 422 and the recessed surface 424 form a keyed interface to engage with and couple the second connection component 182 of the wear bar 500.

The void 426 extends into the bracket plate 420 from the recessed surface 424. The void 426 receives and engages with the fastener 502. In this implementation, the void 426 extends through the bracket plate 420 to the fixed bracket body 404. In this implementation, the void 426 is threaded. Alternatively, the void 426 could be a smooth bore and the bracket 400 could include an additional capture component to engage the threads of the fastener 502 that can be coupled to an inner facing surface 466 opposite the recessed surface 424 (that is, inside the fixed bracket body 404). For example, the void 426 can be a smooth bore and a brazed insert or welded insert can be positioned on the inner facing surface 466 to engage the fastener 502. In some implementations, the void 426 is a through-hole that extends completely through the bracket plate 420. In some implementations, the void 426 is a blind-hole that does not extend completely through the bracket plate 420.

Referring to FIGS. 4-5 and 11-12, the second connection component 182 of the wear bar 500 receives and couples to the second connection component 152a of the fixed bracket 400 to support the wear bar 500 at the second end 158. The second connection component 182 of the wear bar 500 has a wear bar plate 512 that is positioned at the second end 158 of the wear bar 500 and couples to the bracket plate 420 of the fixed bracket 400. The wear bar plate 512 extends from the first surface 508 of the wear bar 500 to an opposite side of the first surface 508 than which the cavity 536 sits. In this implementation, the wear bar plate 512 and the cavity 536 extend from the first surface 508 perpendicularly in opposite directions.

As can be seen in FIG. 11, the wear bar plate 512 defines a key 514 and an aperture 516. The key 514 mates with the recessed surface 424 of the bracket plate 420 and the first surface 422 of the bracket plate 420. Referring to FIG. 12, the key 514 extends from an inner surface 538 of the wear bar plate 512 by a height 518. In this implementation, the inner surface 538 is offset from the wear bar body 504 by a chamfer 540 by a distance 544. The key 514 is sized and shaped to couple to and engage the recessed surface 424 and the first surface 422 to support the wear bar 500. The aperture 516 extends through the key 514. The aperture 516 is sized to allow the fastener 502 to pass through the wear bar plate 512 and engage the void 426 of the bracket plate 420, locking the wear bar plate 512 to the bracket plate 420 and constraining the wear bar 500 in three axes.

The wear bar body 500 has landing protrusions 546 extending from the wear bar plate 512 in the height 178 direction. The landing protrusions 546 are sized to receive a tool, such as bearing puller or jaw puller to aid in separating the wear bar 500 from the fixed bracket 400.

Referring to FIGS. 5-6 and 10, the fixed bracket-third connection component 154 receives and couples to the wear bar-third connection component 184 to support the wear bar 500 at a third point between the pair of the fixed bracket-first connection component 150 and the wear bar-first connection component 180 and the pair of the fixed bracket-second connection component 152 and the wear bar-second connection component 182. In this implementation, the fixed bracket-third connection component 154 is a U-shaped boss 430 positioned on the first surface 406 of the fixed bracket 400. Referring to FIGS. 6 and 10, the U-shaped boss 430 has a first end 432, a second end 434 opposite the first end 432 that defines an opening 436, and opposing inner surfaces 438a, 438b. The opening 436 of the U-shaped boss 430 is sized and shaped to receive and couple to the third connection component 184 of the wear bar 500 in order to support the wear bar 500 and couple the wear bar 500 to the fixed bracket 400. In this implementation, the opposing inner surfaces 438a, 438b are parallel or substantially parallel. In this implementation, the opposing inner surfaces 438a, 438b of the U-shaped boss 430 taper toward each other from the opening 436 to a bottom inner surface 440 of the U-shaped boss 430.

In some implementations, the second connection components 152, 182 include a shear pin void defined by a combination of both the wear bar 500 and the fixed bracket 400, along with a shear pin positioned in the shear pin void. The shear pin can be placed into the shear pin void to further couple the wear bar 500 to the fixed bracket 400. The shear pin void extends from the top surfaces of the wear bar 500 and the fixed bracket 400 into the wear bar 500 and the fixed bracket 400 into the wear bar 500 and the fixed bracket 400 to the respective bottom surfaces.

Referring to FIGS. 4-5 and 11-12, the third connection component 184 of the wear bar 500 receives and couples to the third connection component 154 of the fixed bracket 400 to support the wear bar 500 between the first end 156 and the second end 158. As can be seen in FIGS. 11 and 12, the third connection component 184 of the wear bar 500 includes a block 520 positioned on the first surface 508 of the wear bar 500. The block 520 is sized and shaped to pass through the opening 436 of the U-shaped boss 430 (shown in FIGS. 5-6 and 10) and couple to U-shaped boss 430. The block 520 can be welded to the first surface 508 to slot into the U-shaped boss 430. In some implementations, the opposing inner surfaces 438a, 438b of the U-shaped boss 430 are tapered at an angle that enables the U-shaped boss 430 to clear any weld fillet that may be present on the block 520 when coupling the block 520 to the U-shaped boss 430.

The block 520 has a first end 522 and a second end 524 oriented toward the first end 156 and the second end 158, respectively, of the fixed bracket 400 when the wear bar 500 is coupled to the fixed bracket 400. In this implementation, the first and second ends 522, 524 of the block 520 are rounded. In addition, the block 520 has opposing side surfaces 526a, 526b. The opposing side surfaces 526a,526b frictionally engage with opposing inner surfaces 438a, 438b of the U-shaped boss 430, and the frictional engagement between the opposing side surfaces 526a, 526b and the inner surfaces 438a, 438b of the U-shaped boss 430 couples the wear bar 500 to the fixed bracket 400. In this implementation, the opposing side surfaces 526a, 526b are parallel or substantially parallel. In this implementation, the opposing side surfaces 526a,526b taper toward each other from the second end 524 to the first end 522 such that the opposing side surfaces 526a, 526b of the block 520 align with the opposing inner surfaces 438a, 438b of the U-shaped boss 430 when the wear bar 500 is coupled to the fixed bracket 400. In other words, the block 520 can wedge into the opening 436 of the U-shaped boss 430, coupling the wear bar 500 to the fixed bracket 400.

In some implementations, the block 520 can couple to the U-shaped boss 430 through a non-interference fit (i.e., a clearance fit), a transition fit, or an interference fit. In some implementations, the U-shaped boss 430 and the block 520 can couple together by a mechanical lock between the opposing side surfaces 526a, 526b and the opposing inner surfaces 438a, 438b. For example, block 520 can couple to the U-shaped boss 430 through using a t-slot type interface or some other undercut feature.

Referring to FIGS. 4, 5, 6, 11, and 12, the fixed bracket 400 includes the pair of tabs 442 that extend from the boss 402 in a direction away from the second end 158. The tabs 442 can clear the tracks 108 of any refuse that may exist on or near the tracks 108 as the refuse packer 110 is retracted from the second position 136 to the first position 134. The tabs 442 can plow the refuse away from the tracks 108 toward a center area of the refuse packer 110.

In this implementation, the tabs 442 have rounded corners 444. The rounded corners 444 can reduce spearing of some refuse such as cardboard. In other implementations, the tabs 442 may have square corners or another suitably shaped corner.

In this implementation, a first portion 446 of the tab 442 extends farther from the boss 402 in a direction away from the second end than a second portion 448 of the tab. In some implementations, the tabs 442 have a flat or curved face (i.e., a plate or body) to plow the refuse on or near the tracks 108 off the tracks 108.

Each tab 442 can include an aperture 450. The apertures 450 are sized to receive a tool such as a hook, a chain, or a rod that can be used to facilitate movement of the refuse packer 110 or removal of the wear bar 500 relative to the fixed bracket 400. When the first portion 446 of the tab 442 extends farther from the boss than a second portion 448, the aperture 450 can be positioned on the first portion 446. In this implementation, the aperture 450 is oval-shaped, however, any other shape can be used.

In this implementation, the fixed bracket body 404 is a square tube. In other words, the fixed bracket body 404 is a hollow tube with a square-shaped cross-section. In this implementation, the fixed bracket body 404 has a chamfer 474 to mate with the bracket plate 420. The chamfer 474 faces the bracket plate 420 and locates the bracket plate 420 on the fixed bracket body 404 to facilitate welding of the bracket plate 420 to the fixed bracket body 404. The bracket plate 420 inserts partially into the second end 158 of the fixed bracket body 404 and bottoms out on the chamfer 474.

Referring to FIGS. 5 and 6, the fixed bracket 400 can include a pair of angled plates 452 coupled about the bracket body 404. The angled plates 452 can reinforce or stiffen the fixed bracket body 404. For example, the angled plates 452 can be welded to the bracket body 404 above and below the bracket body 404. In this implementation, ends of the angled plates 452 are coplanar with ends of the fixed bracket body 404. In this implementation, the first end 156 of the fixed bracket body 404 (shown in FIG. 6) fits about an extended portion 456 of the boss 402 and includes a notch 454 generally similar to the cavity 536 to fit about the extended portion 456. As will be described in further detail herein, the extended portion 456 defines an aperture 458 for grease received from a greasing system 1300 to flow through the wear bar 500 to the tracks 108.

In addition, as can be seen in FIGS. 11-12, the wear bar body 504 has a first surface 508 which extends between the first end 156 and the second end 158. The first surface 508 of the wear bar body 504 is oriented toward the first surface 406 of the fixed bracket 400 when the wear bar 500 is installed on the fixed bracket 400. In this implementation, the wear bar body 504 is a square tube. In other words, the wear bar body 504 is a hollow tube with a square-shaped cross-section.

Referring to FIGS. 11-12, the wear bar 500 can include another pair of angled plates 452 coupled about the wear bar body 504. For example, the angled plates 452 can be welded to the wear bar body 504. In this implementation, ends of the angled plates 452 of the wear bar 500 are coplanar with ends of the wear bar body 504.

Referring to FIGS. 4-5 and 11-12, the wear bar body 504 can be defined by a top surface 528, a bottom surface 530, a side surface 532, and the first surface 508. The top surface 528 and the bottom surface 530 are coupled to the first surface 508 and the side surface 532. The top surface 528 is opposite the bottom surface 530. The side surface 532 is opposite the first surface 508.

In this implementation, the wear bar 500 can include multiple wear plates 534 coupled to the top surface 528, the side surface 532, and the bottom surface 530 of the wear bar body 504. When the wear bar 500 includes the angled plates 452, the wear plates 534 are positioned outside the angled plates 452. The wear plates 534 can be formed of a material that has a higher hardness or higher abrasion resistance than other components of the wear bar 500. For example, the wear plates 534 can be AR500 steel. For example, the wear plates 534 can be a welded wear surface, hard-facing, or a weld overlay. The wear plates 534 can cover some or all of the top surface 528, the side surface 532, and the bottom surface 530.

The wear bar 500 can include tabs 542. The tabs 542 are generally similar to the tabs 442 and, similar to tabs 442, tabs 542 can be used to clear refuse on or near the tracks 108 off the tracks 108. The tabs 542 of the wear bar extend from the second end 158 in the length direction 116 away from the first end 156.

As depicted in FIGS. 4 and 5, in this implementation, the fixed bracket 400 is welded to the refuse packer 110. The wear bar 500 is easily removable from the fixed bracket 400, which allows the wear bar to be easily replaced. When the operator desires to replace the wear bar 500, for example, when a wear condition of the wear plates 534 reaches or exceeds a wear threshold (i.e., a quantity of the wear plates 532 has been removed by friction on the tracks 108), the operator can easily disconnect the worn wear bar 500 from the fixed bracket 400. The operator can then install a new wear bar 500.

In this implementation, the refuse packer 110 is moved to the rear end 140 to remove the worn wear bar 500. In this implementation, the refuse packer 110 can be removed from the storage body 106 to replace the worn wear bar 500.

The original fastener 502 is removed. The wear bar 500 is removed from the fixed bracket 400 by an operator by moving the wear bar 500 in the length direction 174 away from the refuse packer 110 to separate from the fixed bracket 400, with the fixed bracket-first connection component 150 parting from the wear bar-first connection component 180, the fixed bracket-second connection component 152 parting from the wear bar-second connection component 182, and the fixed bracket-third connection component 154 parting from the wear bar-third connection component 184 generally simultaneously. Another wear bar 500 is coupled to the fixed bracket 400 by an operator by moving the wear bar 500 in the length direction 174 toward the refuse packer 110 to contact the fixed bracket 400, with the fixed bracket-first connection component 150 contacting the wear bar-first connection component 180, the fixed bracket-second connection component 152 contacting the wear bar-second connection component 182, and the fixed bracket-third connection component 154 contacting the wear bar-third connection component 184 generally simultaneously. Once the wear bar 500 is positioned on the fixed bracket to engage the connection components 150/180, 152/182, 154/184, the operator places the fastener 502 through the aperture 516 and locks the wear bar 500 to the fixed bracket 400 by engaging and tightening the threads 510 of the fastener 502 into the threads of the void 426 of the bracket plate 420. In this implementation, the operator can torque the fastener 502 to a torque threshold range.

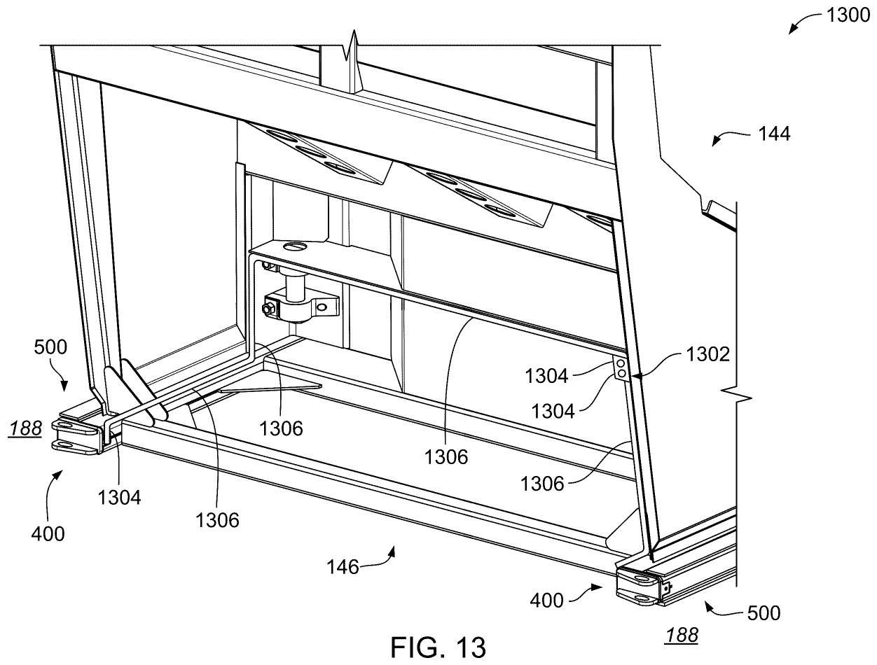

In this implementation, the vehicle 100 includes a grease assembly that can be used to reduce the friction between the tracks 108 and the wear bar 500 as the refuse packer 110 moves along the tracks 108. FIG. 13 is a perspective view of an example greasing system 1300. Referring to FIGS. 1-4, 6-8, and 13, the vehicle 100 can include a grease system 1300 to supply grease to lubricate the track 108 and/or the wear bar 500. The grease system 1300 supplies grease through the fixed bracket 400 to a space 188 outside the fixed bracket 400 between the fixed bracket 400 and the track 108. Lubricating the track 108 and the wear bar 500 can reduce friction and wear on the wear bar 500 and the track 108. In this implementation, ease of operating (moving the refuse packer 110 between the first position 134 and the second position 136) can be increased by regularly lubricating the tracks 108 and/or wear bar 500 using the greasing system 1300. In this implementation, a life expectancy of the track 108 and the wear bar 500 can be increased by lubricating the track 108 and the wear bar 500.

The grease system 1300 includes a grease bracket 1302, a grease fitting 1304 coupled to the grease bracket 1302, a grease supply conduit 1306, and the fixed bracket 400 (and specifically the boss 402). These components supply grease to the space 188 outside the fixed bracket 400 and the track 108.

Referring to FIGS. 2 and 13, the grease system 1300 includes a grease bracket 1302 that is coupled to the non-refuse contacting surface 146 of the refuse packer 110. The grease bracket 1302 is positioned on the non-refuse contacting surface 146 such that the operator can easily access by hand the grease bracket 1302 through the door 124 of the storage body 106 when the refuse packer 110 is in the first position 134. For example, the operator can simply use a ladder, if necessary, to access the door 124 and can access the grease bracket 1302 through the door 124 in order to provide lubrication to the tracks 108 and wear bar. As a result, by utilizing greasing system 1300, an operator is not required to enter into the interior volume 112 of the storage body 106 (e.g., crawl into the interior volume 112) in order to provide grease to the tracks 108 and wear bar 1500. This significantly increases the safety of greasing the track 108 and the wear bar 500. This also reduces the time required to perform maintenance such as greasing the track 108 and wear bar 500.

The greasing system 1300 further includes a grease fitting 1304 that accepts a supply of grease and passes the grease to the grease supply conduit 1306. For example, the grease fitting 1304 can be a Zerk fitting or a grease nipple. The operator connects a grease source, such as a grease gun to the grease fitting 1304 when the door 124 is open and the refuse packer 110 is in the first position 134 and flows the grease from the grease source into the grease fitting 1304.

Alternatively or in addition, the grease source used to supply grease to the grease fitting 1304 can be a grease reservoir coupled to the non-refuse contacting surface 146. The grease reservoir can supply grease to the grease supply conduits 1306 automatically (on-demand) or on-command. For example, the grease source can include a grease control valve that is used to control the volume and/or rate that grease is supplied from the greasing source to the greasing system 1300.

The grease supply conduit 1306 is coupled between the grease fitting 1304 and the fixed bracket 400. The grease supply conduit 1306 supplies grease from the grease fitting 1304 to the fixed bracket 400. The grease supply conduit 1306 can include multiple conduits to conduct grease from one or more fittings to one or more fixed brackets 400.

Referring to FIGS. 4-8, the fixed bracket 400 receives, passes, and supplies grease to the space 188 outside the fixed bracket 400 on to track 108 and/or the wear bar 500. For example, the fixed bracket 400 is coupled to the grease supply conduit 1306 and receives grease from the grease supply conduit 1306 and the fixed bracket 400 includes an aperture 458 sized to pass grease to the track. Referring to FIGS. 4-8, in this implementation, the boss 402 of the fixed bracket 400 receives, passes, and supplies grease to the space 188 outside the fixed bracket 400 on to the track 108 and/or the wear bar 500. The boss 402 defines an aperture 458 extending through the boss 402 between the two opposing surfaces 416a, 416b. The aperture 458 has a diameter 472. The boss 402 and the aperture 458 define a first opening 460 on the opposing surface 416a and a second opening 462 on the opposing surface 416b. The first opening 460 receives grease from the grease supply conduit 1306 and passes the grease to the aperture 458 in the direction of arrows 464. The boss 402 is sized around the diameter 472 of the aperture 458 to allow grease to flow through the boss 402. The aperture 458 conducts the grease from the first opening 460 to the second opening 462 through the boss 402. The second opening 462 passes the grease from the aperture 458 to the space 188 outside the fixed bracket 400 (i.e., a space around the boss 402). Passing the grease out the second opening 462 to the space 188 outside the fixed bracket 400 can deposit grease on the track 108 and/or the wear bar 500, lubricating the track 108 and the wear bar 500.

In this implementation, the first opening 460 can accept another grease fitting 1304, and the grease supply conduit 1306 can be coupled to the grease fitting 1304.

A person maintaining the vehicle 100 can lubricate the tracks 108 and the wear bar 500 by supplying grease to the grease fitting 1304 on the grease bracket 1302 from the grease reservoir by a hand pump or other pump, and, in response, the grease fitting 1304 passes the grease from the grease fitting 1304 to multiple grease supply conduits 1306, conducting the grease through the grease supply conduits 1306 to a pair of fixed brackets 400 coupled to a packer 110. The grease then passes through each of fixed brackets 400 to a space outside the fixed brackets 400. For example, the grease can pass through the aperture 458 of the boss 402 in each of the fixed brackets 400 and onto the tracks 108 on the opposite side walls 126, 128 of the storage body 106. As the packer 110 travels along the tracks 108, the grease supplied to the tracks 108 by the greasing system 1300 is spread along the tracks 108 and the wear bars 500, lubricating the tracks 108 and the wear bars 500.

The vehicle 100 can include an onboard computing device to manage, monitor, and/or operate various body components of the vehicle 100. The onboard computing device can be connected to multiple sensors in the vehicle. The onboard computing device can transmit one or more signals over a network or wiring on the vehicle 100 when the onboard computing device senses a state change from any of the sensors.

In some implementations, the grease system 1300 can include one or more oil sensors, and the one or more oil sensors can be used to determine a quantity of oil on the tracks, a quantity of oil supplied to the tracks 108 and the wear bar 500, and/or an amount of grease in the grease reservoir. The oil sensors can be hard-wired or wireless (i.e., Bluetooth, Bluetooth LE, WiFi, or some other wireless protocol) to provide power, control signals, and/or status signals between the oil sensors and the onboard computing device.

The vehicle 100 can include a display in the cab of the vehicle to display images and/or video received from one or more cameras positioned on the vehicle 100. For example, display can be used to monitor image and/or video data of the vehicle components engaging and servicing the refuse container 104. For example, image data generated by one or more cameras onboard the vehicle 100 can be used to determine a quantity of oil on the tracks 108 and the wear bar 500 or a wear condition of the wear bar 500.

In some implementations, the grease system 1300 can include a controller to perform operations including lubricating the tracks 108. The controller can automatically or on command generate command signals to the grease reservoir to dispense grease out of the grease system 1300 onto the tracks 108. In some implementations, a controller causes the greasing system 1300 to automatically dispense grease onto the tracks 108 in response to receiving a signal from one or more oil sensors indicating that the quantity and/or quality of grease present on the tracks 108 is insufficient. In some implementations, the controller causes the greasing system 1300 to automatically dispense grease onto the tracks 108 in response to receiving a signal from an operator of the vehicle engaging an electronic control (e.g., a switch or button) to dispense grease. The controller can be operated from the vehicle 100 via a user interface such as switch or button, or remotely operated. In some implementations, the controller can be configured to cause the greasing system 1300 to automatically dispense grease at preset intervals (e.g., after a particular number of refuse packer 110 cycles, after a particular number of ignition cycles of the vehicle 100, or at a fixed time interval). An automatic grease dispensing system 1300 can include a separate power source such as a battery to power the controller, reservoir, and associated sensors and valves to dispense the grease onto the tracks 108.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claim(s).

What is claimed is:

1. A refuse collection vehicle comprising:
a wheeled vehicle chassis; and
a refuse-collecting body coupled to the wheeled vehicle chassis, the refuse-collecting body comprising:
a refuse storage having a width direction and a length direction;
a track extending along the length direction of the refuse storage; and
a refuse packer comprising:
a ram defining a refuse-contacting surface in the width direction of the refuse storage;
a fixed bracket secured to a lateral surface of the ram in the length direction of the refuse storage; and
a wear bar engaging the track and mechanically coupled to the fixed bracket by a releasable fastener, the wear bar supported on the fixed bracket by at least three spaced apart connection components in the length direction.

2. The refuse collection vehicle of claim 1, wherein the at least three spaced apart connection components comprise:
a first connection component configured to couple a first end of the fixed bracket to a first end of the wear bar;
a second connection component configured to couple a second end of the fixed bracket to a second end of the wear bar, the second end of the fixed bracket opposite the first end of the fixed bracket and the second end of the wear bar opposite the first end of the wear bar; and
a third connection component positioned along the fixed bracket at a distance between the first end and the second end of the fixed bracket, the third connection component configured to couple the wear bar to the fixed bracket between the first ends and the second ends.

3. The refuse collection vehicle of claim 2, wherein the first connection component comprises:
a boss positioned at the first end of the fixed bracket, the boss extending from the first end toward the second end; and
a cavity in the first end of the wear bar, the cavity shaped to mate with the boss about the boss.

4. The refuse collection vehicle of claim 3, wherein the boss is offset from a first surface of the fixed bracket in a first direction.

5. The refuse collection vehicle of claim 4, wherein the second connection component comprises:
a bracket plate positioned at the second end of the fixed bracket, the bracket plate comprising:
a recessed surface; and
a threaded void extending through the bracket plate from the recessed surface;
a wear bar plate positioned at the second end of the wear bar, the wear bar plate comprising:
a key configured to mate with the recessed surface of the bracket plate; and
an aperture extending through the key; and
the releasable fastener comprises threads, the releasable fastener sized to pass through the aperture of the wear bar plate and threadedly couple to the threaded void of the bracket plate to couple the wear bar plate to the bracket plate.

6. The refuse collection vehicle of claim 5, wherein the bracket plate is offset from the first surface in a second direction opposite the first direction.

7. The refuse collection vehicle of claim 5, wherein the wear bar plate extends from the wear bar plate perpendicular past the first surface of the fixed bracket positioning the key to mate with the recessed surface of the bracket plate.

8. The refuse collection vehicle of claim 4, wherein the third connection component comprises:
a U-shaped boss positioned on the first surface of the fixed bracket, an opening of the U-shaped boss oriented toward the second end; and
a block positioned on a first surface of the wear bar, the first surface of the wear bar facing the first surface of the fixed bracket, the block shaped to pass through the opening of the U-shaped boss and couple to U-shaped boss.

9. The refuse collection vehicle of claim 1, wherein the track is a first track, the fixed bracket is a first fixed bracket, and the wear bar is a first wear bar, the refuse-collecting body further comprises a second track extending along the length direction of the refuse storage, the first and second tracks positioned on opposite sides of the refuse-collecting body and the refuse packer comprises:
a second fixed bracket secured to another lateral surface opposite the lateral surface of the ram in the length direction of the refuse storage; and
a second wear bar engaging the second track and mechanically coupled to the second fixed bracket by a second releasable fastener, the second wear bar supported on the second fixed bracket by the at least three spaced apart connection components in the length direction.

10. A packer wear bar assembly comprising:
a fixed bracket assembly configured to couple to a refuse packer, the fixed bracket assembly comprising:
a fixed bracket body with a first end and second end opposite the first end, a first surface of the fixed bracket body extending between the first end and the second end;
a boss positioned at the first end of the fixed bracket body, the boss offset from the first surface in a first direction and extending parallel to the first surface toward the second end;
a bracket plate positioned at the second end of the fixed bracket body, the bracket plate offset from the first surface in a second direction opposite the first direction, the bracket plate comprising a recessed surface and a threaded void extending through the bracket plate from the recessed surface; and
a U-shaped boss positioned on the first surface of the fixed bracket body between the first end and the second end, an opening of U-shaped boss oriented toward the second end;
a wear bar assembly configured to couple to the fixed bracket assembly, the wear bar assembly comprising:
a wear bar body with a first end and second end opposite the first end;
a cavity in the first end of the wear bar body, the cavity shaped to mate with the boss of the fixed bracket assembly about the boss;
a wear bar plate positioned at the second end of the wear bar body, a portion of the wear bar plate extending from the wear bar body perpendicular to the first surface toward and past the first surface of the fixed bracket body, the portion of the wear bar plate comprising:
a key extending from a first surface of the portion to mate with the recessed surface of the bracket plate; and
an aperture extending from a second surface of the portion to the first surface of the portion; and
a block positioned on a first surface of the wear bar body between the first end and the second end, the first surface of the wear bar body facing the first surface of the fixed bracket body, the block shaped to pass through the opening of the U-shaped boss and coupled to U-shaped boss; and
a threaded fastener sized to pass through the aperture of the portion of the wear bar plate and threadedly couple to the threaded void of the bracket plate.

11. The packer wear bar assembly of claim 10, wherein a perimeter of the boss is cross-shaped.

12. The packer wear bar assembly of claim 11, wherein a length of the cross-shaped boss is greater than or equal to a width of the cross-shaped boss.

13. The packer wear bar assembly of claim 10, wherein lengths of two opposing surfaces of the cross-shaped boss are greater than other lengths of two other opposing surfaces of the cross-shaped boss.

14. The packer wear bar assembly of claim 10, wherein:
opposing inner surfaces of the U-shaped boss taper toward each other from the opening of the U-shaped boss to a bottom inner surface of the U-shaped boss; and
opposing side surfaces of the block taper toward each other from the second end to the first end such that the opposing side surfaces of the block align with the opposing inner surfaces of the U-shaped boss.

15. The packer wear bar assembly of claim 10, wherein the block couples to the U-shaped boss by a clearance fit.

16. The packer wear bar assembly of claim 10, wherein:
the fixed bracket assembly further comprises a pair of tabs positioned at the first end, the pair of tabs extending from the boss from the first end away from the second end, each tab of the pair of tabs defining an aperture; and
the wear bar assembly further comprises another pair of tabs coupled to the wear bar plate, the pair of tabs extending from the wear bar plate from the second end away from the first end, each of the other pair of tabs defining another aperture.

17. The packer wear bar assembly of claim 16, wherein the aperture comprises an oval shape.

18. The packer wear bar assembly of claim 16, wherein the pairs of tabs comprise rounded corners.

19. The packer wear bar assembly of claim 16, wherein a first portion of each tab of the pair of tabs extend farther from the boss and plate than a second portion.

20. The packer wear bar assembly of claim 19, wherein the aperture is positioned in the first portion.

21. The packer wear bar assembly of claim 10, wherein the wear bar plate further comprises a plurality of protrusions extending from a side surface of the wear bar plate.

22. The packer wear bar assembly of claim 10, wherein the fixed bracket body and the wear bar body each comprise a respective square tube.

23. The packer wear bar assembly of claim 10, further comprising two pairs of angled plate coupled about the fixed bracket body and the wear bar body.

24. The packer wear bar assembly of claim 23, wherein ends of the angled plate are coplanar with ends of the fixed bracket body and the wear bar body.

25. The packer wear bar assembly of claim 10, wherein the wear bar body further comprises a top surface and a bottom surface coupled to the first surface, and a side surface coupled between the bottom surface and the top surface opposite the first surface, the wear bar assembly further comprises a plurality of wear plates coupled to the top surface, the side surface, and the bottom surface.

26. The packer wear bar assembly of claim 10, wherein the first end of the fixed bracket body comprises a notch configured to mate to the boss.

27. The packer wear bar assembly of claim 10, wherein:
the boss and the cavity comprise a first connection point;
the U-shaped boss and the block comprise a second connection point;
the recessed surface of the bracket plate, the key, and the threaded fastener comprise a third connection point; and
each of first, second, and third connection points restrain movement of the wear bar assembly relative to the fixed bracket assembly in three axes.

28. A refuse packer assembly comprising:
a refuse packer; and
a pair of wear bar assemblies, each wear bar assembly coupled to opposite sides of the refuse packer, each of the wear bar assemblies configured to ride in a respective horizontal groove of a refuse body, each wear bar assembly comprising:
a fixed bracket secured to a length-oriented non-refuse-packing outer surface of the refuse packer; and
a wear bar configured to engage the respective horizontal groove of the refuse body and mechanically coupled to the fixed bracket by a releasable fastener.

29. The refuse packer assembly of claim 28, wherein the wear bar supported on the fixed bracket by at least three spaced apart connection components.
